(19) United States
(12) Patent Application Publication
(10) Pub. No.: US 2022/0398651 A1
(43) Pub. Date: Dec. 15, 2022

(54) METHOD FOR FINDING PRODUCTS IN A NETWORK

(71) Applicant: Patty's GmbH, Hamburg (DE)

(72) Inventor: Andreas Perschk, Hamburg (DE)

(21) Appl. No.: 17/834,072

(22) Filed: Jun. 7, 2022

(30) Foreign Application Priority Data
Jun. 9, 2021 (DE) 102021114901.0

(51) Int. Cl. G06Q 30/06; G06T 11/60

(52) U.S. Cl. CPC G06Q 30/0643; G06Q 30/0627; G06T 11/60

(57) ABSTRACT

A method for finding products in a network is provided. An image representation of a desired object is generated using specifications for an image generation program of an electronic data processing system. The image representation contains at least a part of the features of the desired object. The generated representation is subjected to an image analysis by an electronic data processing system, and a result of the image analysis is then used to search for identical or similar real products in the network. At least one identical or similar real product found by the search is displayed on a display device of an electronic data processing system of the user.

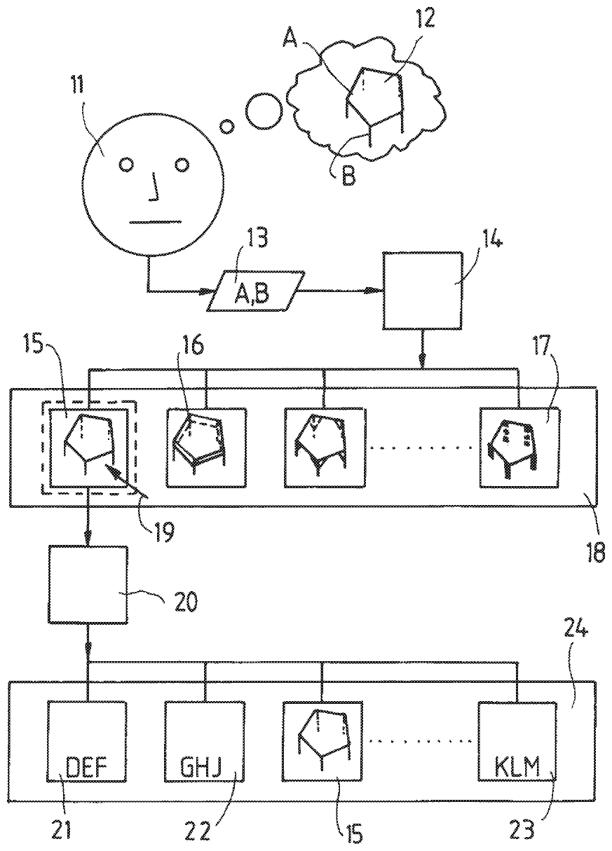

### BACKGROUND

The invention relates to a method for finding products in a network.

It is common nowadays that products are searched for in a data network, viewed and subsequently selected and purchased. For this purpose, so-called online stores have been set up in the network, for example the World-Wide-Web or the Internet, which online stores offer a variety of products that can be selected and subsequently purchased via known payment mechanisms. The prerequisite for this is always that the user also finds the product in question.

From DE 10 2015 112 168 Al it is known to find identical and similar products starting from an image of a real object and to display them on a display device of an electronic data processing system. These products are displayed together with further information for the purchase of the product and are selectable so that they can be purchased by the user.

It is known from DE 10 2016 124 277 Al that an image can be segmented and the objects depicted and recognized in the image can be selected. The objects selected in this way can then be used as the starting point of an image search for identical or similar products, which are then displayed. In this way, the user can quickly and easily obtain a selection of products that are, on the one hand, identical or similar to the selected object. On the other hand, he receives information about the sources of supply of these products.

In the previously known methods, it is always necessary for the desired object or at least a similar object to be present in reality in some way, so that an image of it can be displayed on the display device. This image of the object forms the starting point for the search for this or similar products in the network.

In addition to a search by entering textual search terms, this type of search for real products is promising if at least one image of the desired object exists, on the basis of which the identical or similar products offered and available in the network can be found by means of an image or similarity analysis. If no image of the desired object is available or if only images of only remotely similar objects are available, such search engines cannot provide good results.

### SUMMARY

It is the object of the invention to enable a search for items or products in a network when no images of the item or product are available.

According to the invention, the object is solved by generating an image representation of a desired object with the aid of specifications for an image generation program of an electronic data processing system, which image representation comprises at least some of the features of the desired object, subjecting the generated representation to an image analysis by means of an electronic data processing system, using the result of the image analysis to search for identical or similar real products in the network, and by displaying at least one found identical or similar real product on a display device of an electronic data processing system of the user. The invention makes use here of the fact that image generation programs exist with which images of the objects thus described can be generated by linguistic and/or textual input. In particular, it is provided that the image generation program generates the image representation with the aid of Artificial Intelligence.

Such an image generation program is known, for example, under the name DALL-E or GPT-3. This program generates a pictorial representation or an image of a non-real object based only on textual or linguistic input. This image can be displayed on the display device of the data processing system. Thus, this pictorial representation can form the starting point for an image search in the network.

It is thus in particular possible to find such products in the network which exist only in the imagination of the user or the searcher. For example, the user is looking for a table with five black legs and a blue tabletop, but cannot find an image representation of such a table. Therefore, the user first generates a pictorial representation of such a table with these features using the image generation program. The user can create the specifications for the pictorial representation of the desired object to be generated by means of an acoustic input and/or a text input. It is also possible that such inputs are made by an implemented human-machine interface, through which an input for a data processing system can only be generated via the thoughts or imagination of the user. Such interfaces are known as BCI (Brain- Computer-Interface).

Furthermore, it is alternatively or additionally possible that the input is generated with the help of pictorial elements that are part of the desired object. In the latter case, the user can adopt one or the other design feature from various real images or from various mental features, and thus assemble the desired object according to his ideas. From these individual elements, the image creation program generates a holistic pictorial representation of the desired object, which in many parts also corresponds in detail to the desired object. The subsequent image search can then be carried out on the basis of the accurate image generated in this way.

It is also possible to proceed in such a way that, on the basis of the specifications for the desired or fictitious object, a plurality of pictorial representations of the desired object are generated which are displayed on the display device of the electronic data processing system of the user, and that at least one pictorial representation can be selected by the user for the image analysis. The user is thereby provided with a plurality of suggestions as to what the desired object might look like using these criteria or specifications. This also allows an exact search for an object existing so far only in the imagination of the user in the network.

Furthermore, it is possible that several representations can be selected and that at least one new pictorial representation is generated from the selected representations. The Artificial Intelligence of the image generation program will be able to generate and display more than one pictorial representation from the specifications. The user is then in the position to select those pictures, which match in the one or other detail with its desired object as far as possible. A new pictorial representation of the previously only fictitious object is generated which representation comes very close to the desired object. This new pictorial representation generated from the combination of several images then forms the starting point for the subsequent image search.

It is useful if the generated representation is displayed next to the found item(s) on the display device. This has the advantage that the user always knows which pictorial representation of the object was the starting point of the search. It also allows him to control the quality of the image search. Furthermore, it can be provided that several initial images remain displayed on the display device. This makes it possible for the user to refer back to a previous image search by simple means.

The image analysis preferably comprises a similarity analysis of the image representation. Further input of textual terms can also make the search more accurate. For example, if a dining table is being searched for, the additional input of the search term “dining table” can be used to hide similar coffee tables. This makes the results more accurate.

Further, it is useful if the real products found and displayed can be selected with the operating pointer of the electronic data processing system in order to obtain further information about the product in question. This enables the user, for example, to quickly and easily reach a supplier offering a real product that is similar to the previously only fictitious object. When using a human-machine interface, the operating pointer can also be moved and operated by the user's thoughts. The selection of a particular product can then be made based on thought control alone.

Furthermore, it can be provided that the found products are displayed on the display device according to predeterminable criteria. The predeterminable criteria may be, for example, the purchase price, the availability, the distance to a predeterminable address or the size. The user can thus quickly get to his desired item and, for example, purchase it.

### BRIEF DESCRIPTION OF THE DRAWINGS

The invention is explained in more detail with reference to the schematic drawing.

The single figure shows the flow of the method for finding products in a network.

### DETAILED DESCRIPTION

The user 11 has in his mind's eye a fictitious object 12 which he wishes to acquire, for example. The object has at least two features A, B which the user can describe. The user 11 formulates these two features A, B as input 13 for an electronic data processing system 14.

The input can be textual via a keyboard or acoustic via a voice control. Other input possibilities can also be used to generate the input 13 with the characteristics A, B. For example, combined inputs are also possible, which may also include a graphic or several graphic sketches.

In the data processing system 14 an image generation program is implemented or accessible, which creates at least one pictorial representation 15, 16, 17 of the desired object 12 with the features A, B from this input 13. Such image generation programs are known and use Artificial Intelligence to create a pictorial representation 15, 16, 17 of a corresponding object 12 from the mere input 13 of the features A, B. This object 12 is thus fictitious and does not exist in the real world.

The pictorial representations 15, 16, 17 are displayed on a display device 18 of the user 11. This display device 18 may be, for example, the screen of a computer or a tablet computer or a smartphone. Also, these representations may be displayed in VR (virtual reality) glasses. In any case, these representations are displayed in a manner that is visually perceptible to the user. This also includes the mental display or projection, in which the products or a pictorial representation of the product appear only in front of the user's “mind's eye” via a man-machine interface.

The representations 15, 16, 17 thus generated can be selected with an operating pointer 19. The operating pointer 19 may be the “mouse” pointer of the electronic data processing system 14. In touch-sensitive display devices 18, such as those used in mobile smart phones or tablet computers, the control pointer 19 may also be the user's fingertip or a stylus tip. In VR goggles, the control pointer 19 may be controlled by focusing the eye of the user on one of the pictorial representations. It is also possible to manifest, move and actuate the control pointer 19 by means of a man-machine interface only by the thoughts of the user 11. All possible embodiments of the control pointer result in at least one of the shown pictorial representations 15 being highlighted or selected.

The selected pictorial representation 15 is fed to another or the same data processing system 20. In this, an image processing program runs which performs a similarity search within a network for identical or similar products. The products thus found are real products which exist and can be purchased. These products 21, 22, 23 thus found are displayed on another page 24 of the user's display device or other data processing equipment. It is useful if the selected pictorial representation 15 is also displayed on this page 24 of the display device. Provision may also be made for the search history to be displayed on the display device or stored in a retrievable manner. In this way, the search remains clear.

The products 21, 22, 23 found can be displayed with further information DEF, GHJ, KLM. This information may include in particular the seller, the dimensions, the place of sale and the purchase price. The user 11 is thus able to easily find and purchase a product 21, 22, 23 that is at least similar to his designed object 12 in the network.

1. A method for finding products in a network, comprising the steps of:
generating at least one image representation of a fictitious object with the aid of specifications for an image generation program of an electronic data processing system, the at least one image representation containing at least some of features of the fictitious object;
subjecting the at least one of the generated representation to image analysis by the electronic data processing system;
using a result of said image analysis to search for identical or similar real products in the network; and
displaying at least one identical or similar real product, found as a result of the search, on a display device of a user.

2. The method according to claim 1, wherein the image generation program generates the at least one image representation with the aid of Artificial Intelligence.

3. The method according to claim 2, wherein the specifications for the at least one image representation of the fictitious object to be generated are made by an acoustic input, a text input, and/or pictorial elements that are part of a desired object and/or by a man-machine interface based on imagination or thoughts of the user.

4. The method according to claim 3, wherein a plurality of image representations of the fictitious object is generated on the basis of the specifications, which image representations are displayed on the display device, and wherein at least one of the plurality of image representations is selected by the user for the image analysis.

5. The method according to claim 4, wherein several of the plurality of image representations are selectable and at least one new pictorial representation is generated from the selected image representations.

6. The method according to claim 5, wherein the at least one generated image representation is displayed on the display device next to the at least one identical or similar real product.

7. The method according to claim 6, wherein the image analysis comprises a similarity analysis of the at least one image representation.

8. The method according to claim 7, wherein the at least one identical or similar real product found by the search is selectable with an operating pointer to obtain further information about the at least one identical or similar real product.

9. The method according to claim 8, wherein a plurality of identical or similar real products are found by the search and are displayed on the display device according to predeterminable criteria.

10. The method according to claim 1, wherein the specifications for the at least one image representation of the fictitious object to be generated are made by an acoustic input, a text input, and/or pictorial elements that are part of a desired object and/or by a man-machine interface based on imagination or thoughts of the user.

11. The method according to claim 1, wherein a plurality of image representations of the fictitious object is generated on the basis of the specifications, which image representations are displayed on the display device, and wherein at least one of the plurality of image representations is selected by the user for the image analysis.

12. The method according to claim 11, wherein several of the plurality of image representations are selectable and at least one new pictorial representation is generated from the selected image representations.

13. The method according to claim 1, wherein the at least one generated image representation is displayed on the display device next to the at least one identical or similar real product.

14. The method according to claim 1, wherein the image analysis comprises a similarity analysis of the at least one image representation.

15. The method according to claim 1, wherein the at least one identical or similar real product found by the search is selectable with an operating pointer to obtain further information about the at least one identical or similar real product.

16. The method according to claim 1, wherein a plurality of identical or similar real products are found by the search and are displayed on the display device according to predeterminable criteria.
